(19) United States
(12) Patent Application Publication
(10) Pub. No.: US 2011/0119200 A1
(43) Pub. Date: May 19, 2011

(54) METHOD AND SYSTEM FOR DETERMINING FREIGHT RATE AND FEES

(75) Inventor: Hiromi HATTA, Osaka (JP)

(73) Assignees: SANAI CO., LTD., Osaka (JP); UNYU CHUSHO KIGYO KUIKI HENKAKU BUTSURYU KYOKAI, Osaka (JP)

(21) Appl. No.: 12/947,158

(22) Filed: Nov. 16, 2010

(30) Foreign Application Priority Data
Nov. 19, 2009 (JP) 2009-263925

(51) Int. Cl. G06Q 30/00

(52) U.S. Cl. 705/335

(57) ABSTRACT

A method for determining a freight rate and fees and a system therefor that can determine additional fees for additional distances, detention times, and distances of overtime transportation, other than the time and distance for a single service of consignment transportation. According to the method, upon receiving any of waiting, loading, completion, rest, unloading, addition, and additional loading instructions, a vehicle-mounted apparatus receives positional information of a transportation vehicle from a GPS satellite, and associates information corresponding to the received instructions with the positional information and a time at which the instructions have been received, for storage as service data; the server determines a reference freight rate based on designated loading and unloading points; when information associated with the additional and additional unloading instructions have been found from the service data, the server determines an additional travel distance, to determine an additional distance fee therefor; the server determines an amount of time that the time required at each of the loading and unloading points exceeds a prescribed reference time to be a detention time, to determine a detention fee therefor; and the server determines a distance traveled during late night and early morning hours and a distance traveled on regular and public holidays, to determine an overtime transportation fee therefor.

### BACKGROUND OF THE INVENTION

(1) Field of the Invention

The present invention relates to a system for determining fees charged for consignment transportation in the transportation industry (such fees are hereinafter also referred to as “a freight rate and fees”, including a freight rate and other fees); more particularly, to a system that determines actual fees based on an actual travel distance and time covered by consignment transportation, with the aid of a vehicle-mounted measuring apparatus.

(2) Description of the Related Art

In the business practice of the current transportation industry, transportation companies report their freight rates and fees (hereinafter referred to as the “Guide for Reported Freight Rates and Fees”) to the Ministry of Land, Infrastructure, Transport and Tourism. When transportation work is consigned, information regarding the place where goods are to be loaded onto a transportation vehicle (hereinafter referred to as a “loading point”) and the place where the goods are to be unloaded from the transportation vehicle (hereinafter referred to as an “unloading point”) is provided from the client, and based on such information, the route in which the travel distance between two points, i.e., the loading point and the unloading point, is the shortest, is calculated with reference to a distance chart or the like. Further, a reported distance freight rate (also referred to as a reference freight rate) is calculated based on the reported freight rate described in the Guide for the Reported Rates and Fees, taking into account the weight or volume of the load. This reported distance freight rate is presented as an estimate to the client for negotiation, and a rate that is established after negotiation is charged as the actual freight rate (i.e., the actually charged freight rate, or actual contract freight rate) to the client after the transportation is completed.

Further, a digital tachograph (DTG) equipped with a Global Positioning System (GPS) (e.g., a product of Yazaki Corporation) and other like travel information-collecting devices mounted in today's transportation vehicles are used to collect and store various types of information as follows for each transportation service: the time required for the transportation vehicle to cover the entire distance; a stored sum of travel distances; time-series travel distances; time-series velocity changes; events such as loading and unloading of goods, break time, fuel filling, etc.; the latitude and longitude (location) determined by GPS at given time intervals and at the time of various events, etc. The collected information is input to a server or a personal computer found at the main office of the transportation company. Such information is mainly used for tracking and management, for example, tracking of the service route, confirmation of events such as loading and break time during service, etc., and for managing employee attendance and vehicles. However, the information has not been used for the calculation of freight rates.

As described above, in the current transportation industry, the freight rate calculation is solely based on information regarding the loading point and the unloading point, which is provided from the client who requests transportation. An approximate distance freight rate is estimated from the distance between the loading point and the unloading point, and this rate is presented to the client. An actual freight rate is determined by negotiation with the client, and the order is accepted with the actual freight rate. After the transportation service is provided, the actual freight rate is charged to the client.

However, in the actual transportation, the loading time needs to be considered in addition to the weight and volume of the load, as well as the reference distance of the transportation. There are cases where a longer time and/or longer travel distance than the original estimate was required because of the following reasons: the loading could not be performed at the specified time, the loading took extra time, waiting time occurred because unloading could not be performed at the specified time, a new destination was added in addition to the original unloading point, etc.

For transportation employees, waiting time and long loading and unloading time are major factors that reduce the vehicle operating rate, which leads to a reduction in transportation income. However, there is a problem in the practice of the current transportation industry. That is, because evidence of waiting time and extra-long loading and unloading time cannot be provided, a fee for extra detention times cannot be charged to the client, due to the fact that the additional charge is considered to be groundless.

Further, estimated freight rates and actual freight rates are fees based on a reference distance. Even if a contract is made with a freight rate that is based on the reference distance, when the client changes or adds an unloading point, it will take the transportation employees more working time and a longer travel distance. However, there is also another problem in the practice of the current transportation industry. That is, a fee for such an additional travel distance also cannot be charged to the client due to the fact that the additional charge is considered to be groundless.

Still further, there is another problem. That is, although rules for transportation during late night and early morning or on regular holidays and public holidays are roughly specified in the Guide for Reported Rates and Fees, in actuality, such fees are not calculated and charged to the client.

### BRIEF SUMMARY OF THE INVENTION

The present invention has been made in order to solve the above-described prior art circumstances. An object of the invention is to provide a method and system for determining a freight rate and fees that measure a travel distance and time using a vehicle-mounted measuring apparatus, to thereby quantify and clarify an actual service distance using the measured information, and to thereby enable a quantitative determination of any additional fees.

In order to achieve the above-mentioned object, a first aspect of the invention provides a method (1) for determining a freight rate and fees that determines fees charged for consignment transportation based on a time and distance required for transportation, using a server and a vehicle-mounted apparatus mounted in a transportation vehicle, the method (1) including the steps in which:

upon receiving any of waiting, loading, completion, rest, unloading, addition, and additional loading instructions, the vehicle-mounted apparatus receives positional information of the transportation vehicle from a GPS satellite, and associates information corresponding to the received instructions with the positional information and a time at which the instructions have been received, for storage as service data;

the server determines a reference freight rate based on a reported freight rate, using a reference distance calculated based on a shortest route between designated loading and unloading points that have been found based on pre-stored map data, as well as the weight or volume of a load;

when information associated with the addition, as well as information associated with the additional unloading have been found from the service data, the server determines, as an additional distance, a distance from a position specified by stored positional information associated with the addition to a position specified by stored positional information associated with the additional unloading, to determine an additional distance fee for the additional distance;

when a loading/unloading time required for each loading or unloading event, as well as information associated with waiting and/or completion have been found from the service data, the server determines a waiting time before and/or after the event, and determines an amount of time that the sum of the waiting time and the loading/unloading time exceeds a prescribed reference time to be a detention time, to determine an additional detention fee for the detention time;

the server determines, from the service data, a distance traveled during late night and early morning hours, and a distance traveled on regular and public holidays, and multiplies each of the resulting distances by a prescribed rate to determine a sum total of the resulting values to be an extra overtime fee; and

the server determines a total amount by adding up an actual contract freight rate determined based on the reference freight rate, the additional distance fee, the detention fee, and the extra overtime fee, and determines the total amount to be the fees charged.

A second aspect of the invention provides a method (2) for determining a freight rate and fees that determines fees charged for consignment transportation based on a time and distance required for transportation, using a server and a vehicle-mounted apparatus mounted in a transportation vehicle, the method including the steps in which:

upon receiving any of waiting, loading, completion, rest, unloading, addition, and additional loading instructions, the vehicle-mounted apparatus receives positional information of the transportation vehicle from a GPS satellite, and associates information corresponding to the received instructions with the positional information and a time at which the instructions have been received, for storage as service data;

the vehicle-mounted apparatus sums up a first travel distance, which is a distance that the transportation vehicle traveled from the time of receiving loading instructions to the time of receiving unloading instructions, and a second travel distance, which is a distance that the transportation vehicle traveled from the time of receiving addition instructions to the time of receiving additional unloading instructions, and adds the sum of the first and second distances to the service data for storage;

the server determines a reference freight rate based on a reported freight rate, using the first travel distance read from the service data stored by the vehicle-mounted apparatus, and using the weight or volume of a load;

when a change or addition event for loading or unloading has been found from the service data, the server determines the second travel distance read from the service data to be an additional distance, to determine an additional distance fee for the additional distance;

when a loading/unloading time required for each loading or unloading event, as well as information associated with waiting and/or completion have been found from the service data, the server determines a waiting time before and/or after the associated event, and determines an amount of time that the sum of the waiting time and the loading/unloading time exceeds a prescribed reference time to be a detention time, to determine an additional detention fee for the detention time;

the server determines, from the service data, a distance traveled during late night and early morning hours and a distance traveled on regular and public holidays, and multiplies each of the resulting distances by a prescribed rate to determine a sum total of the resulting values to be an extra overtime fee; and

the server determines a total amount by adding up an actual contract freight rate determined based on the reference freight rate, the additional distance fee, the detention fee, and the extra overtime fee, and determines the total amount to be the fees charged.

A third aspect of the invention provides a system (1) for determining a freight rate and fees that estimates a reference freight rate for consignment transportation based on a reported freight rate, and that determines fees charged for the consignment transportation based on a time and distance required for transportation. The system includes a server and a vehicle-mounted apparatus mounted in a transportation vehicle.

The vehicle-mounted apparatus includes:

a positional information acquisition unit that receives positional information of the transportation vehicle from a GPS satellite;

a time-measuring unit that acquires a time;

an operating unit that receives any of waiting, loading, completion, rest, unloading, addition, and additional unloading instructions; and

a drive that stores data in a removable storage medium.

The vehicle-mounted apparatus associates information corresponding to the received instructions with the time acquired from the time-measuring unit and the positional information acquired from the GPS satellite upon receiving the instructions, for storage into the removable storage medium as service data.

The server includes a drive that writes and reads to and from the removable storage medium, and performs:

transportation distance determination processing in which a shortest route from a first point to a second point is found based on pre-stored map data, and a transportation distance is determined based on the shortest route;

reference freight rate determination processing in which a reference freight rate is determined based on a reported freight rate, using a reference distance calculated by the transportation distance determination processing, taking a loading point and unloading point designated by a shipper as the first point and second point, respectively, as well as using the weight or volume of a load;

additional distance fee determination processing in which, when a change or addition event for loading or unloading has been found from the service data, an additional distance fee for an additional distance calculated by the transportation distance determination processing is determined;

detention fee determination processing in which, when a loading/unloading time required for each loading or unloading event, as well as information associated with waiting and/or completion have been found from the service data, a waiting time before and/or after the associated event is determined, and an amount of time that the sum of the waiting time and the loading/unloading time exceeds a prescribed reference time is determined to be a detention time, to determine an additional detention fee for the detention time;

extra overtime fee determination processing in which a distance traveled during late night and early morning hours and a distance traveled on regular and public holidays are determined from the service data, and each of the resulting distances is multiplied by a prescribed rate to determine a sum total of the resulting values to be an extra overtime fee; and

fee charge determination processing in which a total amount is determined by adding up an actual contract freight rate determined based on the reference freight rate, the additional distance fee, the detention fee, and the extra overtime fee, and the resulting total amount is determined to be the fees charged.

A fourth aspect of the invention provides a system (2) for determining a freight rate and fees that estimates a reference freight rate for consignment transportation based on a reported freight rate, and that determines fees charged for the consignment transportation based on a time and distance required for transportation. The system includes a server and a vehicle-mounted apparatus mounted in a transportation vehicle.

The vehicle-mounted apparatus includes:

a positional information acquisition unit that receives positional information of the transportation vehicle from a GPS satellite;

a time-measuring unit that acquires a time;

an operating unit that receives any of waiting, loading, completion, rest, unloading, addition, and additional unloading instructions; and

a drive that stores data in a removable storage medium.

The vehicle-mounted apparatus associates information corresponding to the received instructions with the time acquired from the time-measuring unit and the positional information acquired from the GPS satellite upon receiving the instructions, for storage into the removable storage medium as service data.

The vehicle-mounted apparatus sums up a first travel distance, which is a distance that the transportation vehicle traveled from the time of receiving loading instructions to the time of receiving unloading instructions, and a second travel distance, which is a distance that the transportation vehicle traveled from the time of receiving addition instructions to the time of receiving additional loading instructions; and adds the sum of the first and second distances to the service data for storage.

The server includes a drive that writes and reads to and from the removable storage medium, and performs:

reference freight rate determination processing in which the first travel distance is read from the service data as a distance between a loading point and unloading point designated by a shipper, to be determined as a reference distance, and a reference freight rate is determined based on a reported freight rate, using the reference distance and the weight or volume of a load;

additional distance fee determination processing in which, when a change or addition event for loading or unloading has been found from the service data, the second travel distance is read from the service data as an additional distance, and an additional distance fee for the additional distance is determined;

additional detention fee determination processing in which, when a loading/unloading time required for each loading or unloading event, as well as information associated with waiting and/or completion have been found from the service data, a waiting time before and/or after the associated event is determined, and an amount of time that the sum of the waiting time and the loading/unloading time exceeds a prescribed reference time is determined to be a detention time, to determine an additional detention fee for the detention time;

extra overtime fee determination processing in which, based on sum data of the travel distances in the service data, a distance traveled during late night and early morning hours and a distance traveled on regular and public holidays are determined, and each of the resulting distances is multiplied by a prescribed rate to determine a sum total of the resulting values to be an extra overtime fee; and

fee charge determination processing in which a total amount is determined by adding up an actual contract freight rate determined based on the reference freight rate, the additional distance fee, the detention fee, and the extra overtime fee, and the resulting total amount is determined to be the fees charged.

In accordance with the method for determining a freight rate and fees, and the system for implementing the method of the present invention, the entire distance covered by a single transportation request is monitored, and the time and travel distance used for the service provision are measured, thereby allowing presenting, to the client, convincing numerical information regarding any additional services. Further, by quantitatively determining additional fees based on this numerical information, additional fees that should be paid for the additional service's can be readily charged to the client. This contributes to improving the soundness of the form of business, and enhancing the services of the transportation industry.

Furthermore, by measuring the amount of overtime work done during late night and early morning hours, and on regular and public holidays, the additional fees can be charged to the client, and a basis for legal compliance can also be provided.

### BRIEF DESCRIPTION OF SEVERAL VIEWS OF THE DRAWING

FIG. 1 is a block diagram schematically showing the configuration of a system for determining a freight rate and fees according to one embodiment of the invention;

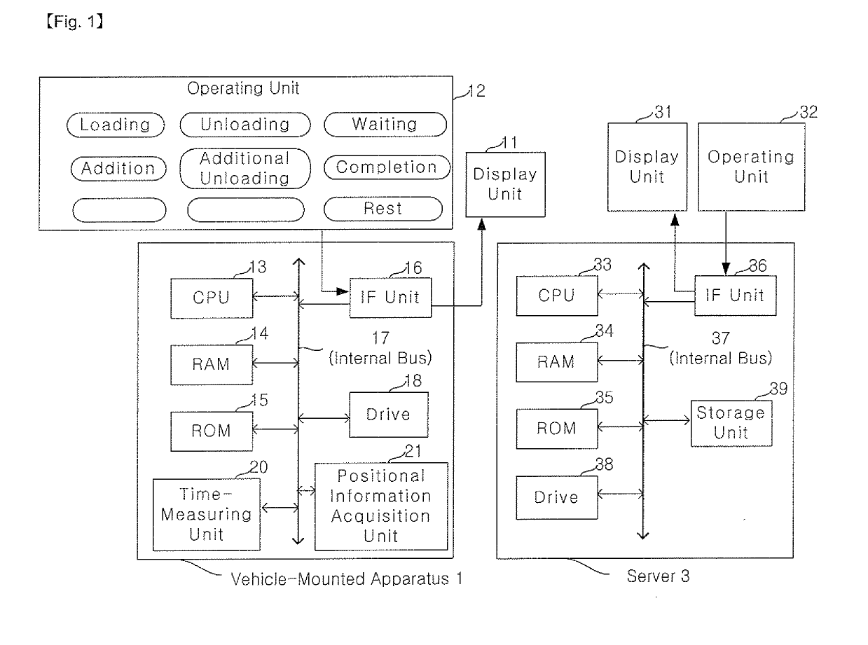

FIG. 2 is a block diagram showing the functions of programs stored in the ROM of the server 3 of the system of FIG. 1; and

FIG. 3 is a diagram showing one example of a document for presenting to a client a contract freight rate together with additional fees.

### DETAILED DESCRIPTION OF THE INVENTION

A system for determining a freight rate and fees according to one embodiment of the invention will be described below, referring to the appended drawings.

The system for determining a freight rate and fees according to this embodiment comprises a vehicle-mounted apparatus 1 mounted in each transportation vehicle, and a server 3 located at the main office of a transportation company. Each of the vehicle-mounted apparatus 1 and server 3 includes an arithmetic processing unit (hereinafter, the “CPU”) that performs an overall control; a display unit; an operating unit; an interface (IF) unit that interfaces with external units; a non-volatile read-only memory that stores programs and the like (hereinafter, the “ROM”); a volatile rewritable memory that can store data temporarily (hereinafter, the “RAM”); a drive that writes and reads data to and from a portable removable storage medium that is inserted into the drive; and an internal bus that exchanges data (including control information) from one unit to another.

The operating unit 12 of the vehicle-mounted apparatus 1 has buttons for initiating particular events, inputting destinations, and the like. The display unit 11 may be a display screen such as a liquid crystal panel. The operating unit 32 of the server 3 has an operating means such as a keyboard or a pad for computers. The display unit 31 of the server 3 may include a display screen (e.g., a liquid crystal panel) and an output unit such as a printer.

In addition to these function units, the vehicle-mounted apparatus 1 further includes a time-measuring unit 20, such as a timer, that acquires information regarding the current time using an internal clock for output; and a positional information acquisition unit 21 that acquires the current positional information from a GPS satellite for output.

The server 3 also includes a storage unit 39 that stores data permanently.

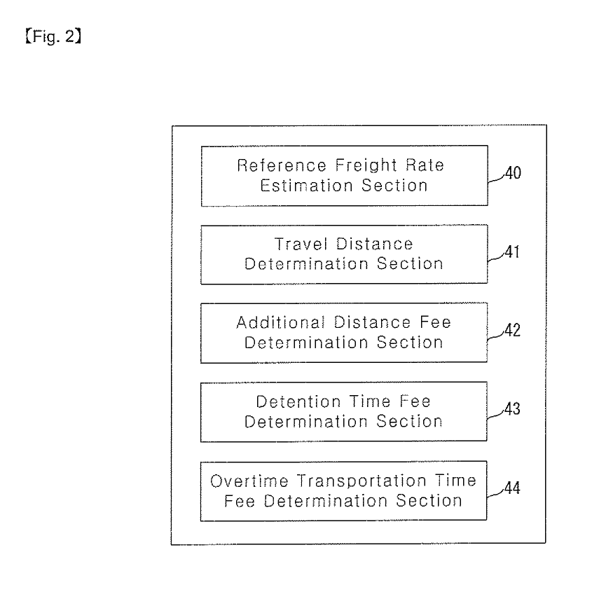

The ROM 35 or storage unit 39 of the server 3 stores programs that implement functions classified into the function sections shown in FIG. 2. The CPU 33 reads these programs, and implements their functions. As shown in FIG. 2, these function sections include a reference freight rate estimation section 40 that estimates a reference freight rate based on the information of loading and unloading points from a client; a travel distance determination section 41 that determines the travel distance between two given points; an additional distance fee determination section 42 that, when there is an additional travel distance other than the reference distance ordered by the client at the time of the request, determines the travel distance and the additional fee therefor; a detention time fee determination section 43 that, when a detention time or waiting time occurs outside the prescribed loading and unloading time, determines the interval of time and the detention fee therefor; and an overtime transportation time fee determination section 44 that, when the travel time of requested transportation includes late night and early morning hours and regular and public holidays, determines the distance traveled during those hours and the additional fee therefor as overtime transportation.

The method for determining a freight rate and fees according to this embodiment will be described below, as the operation of the system for determining a freight rate and fees. It is noted that, when a particular event is stored hereinafter, information (e.g., text data) representing the event is stored. It is also noted that the functions of the function sections 40 to 44 are in practice implemented by the CPU 33; however, for the sake of simplicity, these functions are described as being implemented by the respective function sections.

The server 3 receives input information regarding the date and time of transportation, the amount of a load (weight and/or volume), as well as the loading and unloading points as specified by the client at the time of the request; and stores these items of information in the storage unit 39. The travel distance determination section 41 then finds the shortest route between the loading and unloading points, using electronic map information, and determines the found distance to be a basic distance. Based on reported freight rates listed in a Guide for Reported Freight Rates and Fees that has been registered in the storage unit 39, the reference freight rate estimation section 40 determines the reported distance freight rate associated with the basic distance to be a reference freight rate, and stores the reference freight rate in the storage unit 39.

Optionally, the travel distance determination section 41 may further have the function of determining the basic distance, referring to a distance chart or the like registered in the storage unit 39.

The transportation company negotiates a freight rate with a shipper based on the reference freight rate, and determines the actual freight rate (the actual contract freight rate).

The determined actual contract freight rate is input into the server 3, and stored in the storage unit 39.

A removable storage medium is inserted into the drive 38 of the server 3, and the above-mentioned information regarding the date and time of transportation, the amount of the load, the loading and unloading points, and the freight rate are stored in the storage medium by the CPU 33.

An employee inserts the removable storage medium storing the information regarding the date and time of transportation, the amount of the load, the loading and unloading points, and the freight rate into the drive 18 of the vehicle-mounted apparatus 1 of a given transportation vehicle, and then departs from the garage.

While the transportation vehicle is in service, the CPU 13 of the vehicle-mounted apparatus 1 acquires, at given time intervals, the current position and time via the positional information acquisition unit 21 and time-measuring unit 20, respectively, and also determines time-series of travel distances and a stored sum of travel distances. The CPU 13 then stores the information into the storage medium inserted into the drive 18, thereby monitoring the entire distance of transportation.

After the arrival of the transportation vehicle at a loading point, when the time for loading has been specified, but loading cannot be started at the specified time, the employee may press the “waiting” button on the vehicle-mounted apparatus 1. The CPU 1.3 of the vehicle-mounted apparatus 1 acquires the current time via the time-measuring unit 20, associates the “waiting” event, which is the information representing the start of waiting, with the current time, and stores the “waiting” event (i.e., the information) into the storage medium. The information is stored, for example, as text letters reading “10:00 waiting”. The CPU 13 of the vehicle-mounted apparatus 1 may also acquire the current positional information via the positional information acquisition unit 21 having the GPS function, associate the current time and positional information with the “waiting” event, and then store the “waiting” event (i.e., the information) into the storage medium. The “waiting” event can be released by pressing the next button, for example, the “loading” button. That is, the end of waiting can be proved by storing the “loading” event described later; accordingly, the end of waiting need not be stored.

Upon start of loading at the loading point, the employee presses the “loading” button on the vehicle-mounted apparatus 1. The vehicle-mounted apparatus 1 then acquires the current time, as well as the current positional information via the GPS function, and associates the current time and position with the “loading” event, stores the “loading” event into the storage medium. This loading point is identified as a start point of distance measurement to the delivery place. The pressing of the “loading” button is automatically released immediately after the transportation vehicle has started traveling, or is released by pressing the “completion” button.

After the end of loading work at the loading point, if the transportation vehicle cannot depart immediately due to the shipper's circumstances, the employee may press the “completion” button on the vehicle-mounted apparatus 1. The CPU 13 then acquires the current time and positional information, and associates the current time and position with the “completion” event, for storage into the storage medium. The “completion” event is stored, for example, as text letters reading “10:00 completion-start N:34° 41′ E: 135° 30′”. At the time of departure, the employee presses the “completion” button again, causing the CPU 13 to identify the end of the “completion” event. The CPU 13 in turn acquires the end time, and associates the time with the “completion” event, for storage into the storage medium. The end of the “completion” event is stored, for example, as text letters reading “11:00 completion-end”.

When taking a rest after the start of traveling, the employee may press the “rest” button, causing the CPU 13 of the vehicle-mounted apparatus 1 to acquire the current time and positional information at that time, for storage into the storage medium as a “rest” event. At the end of the rest, the employee may press the “rest” button again, causing the vehicle-mounted apparatus 1 to identify the end of the “rest” event. The CPU 13 in turn acquires the end time, and associates the time with the “rest” event, for storage into the storage medium.

After arrival at the unloading point, if unloading cannot be started immediately, the employee may press the “waiting” button on the vehicle-mounted apparatus 1. The vehicle-mounted apparatus 1 then acquires the current time and positional information, and associates them with the “waiting” event, for storage into the storage medium.

Upon start of unloading, the employee presses the “unloading” button on the vehicle-mounted apparatus 1. The vehicle-mounted apparatus 1 then acquires the current time and positional information, and associates the current time and position with the “unloading” event, for storage into the storage medium. This unloading point is identified as an end point of distance measurement from the loading point to the delivery place. The pressing of the “unloading” button is automatically released immediately after the transportation vehicle has started traveling, or is released by pressing the “completion” button.

After the end of unloading work at the unloading point, if the transportation vehicle does not depart immediately due to shipper's circumstance, the employee may press the “completion” button on the vehicle-mounted apparatus 1. The vehicle-mounted apparatus 1 then acquires the current time and positional information, and associates the current time and position with the “completion” event, for storage into the storage medium. At the time of departure, the employee presses the “completion” button again, causing the vehicle-mounted apparatus 1 to identify the end of the “completion” event. This causes the CPU 13 to acquire the end time, and associate the time with the “completion” event, for storage into the storage medium.

Furthermore, when a change or addition is made to the unloading point at the unloading place, the employee may press the “addition” button, causing the CPU 13 of the vehicle-mounted apparatus 1 to acquire the current time and positional information, and associate the current time and position with the “addition” event, for storage into the storage medium. The position at that time is determined as the start point for distance measurement at the time of a change or addition. The vehicle-mounted apparatus 1 continues to repeat collecting the current time and positional information, and storing them into the storage medium at given time intervals, thereby monitoring the entire distance of transportation.

When there is an additional unloading point, after the arrival at the additional unloading point, the employee may press the “waiting” button at the time of waiting, and press the “additional unloading” button when unloading is started. Moreover, when the employee does not depart immediately after the end of the unloading work, the employee may press the “completion” button. The vehicle-mounted apparatus 1 acquires, in response to the button operation, the start time of the “waiting”, “additional unloading”, or “completion” event, as well as the current position, for storage into the storage medium. When there are a plurality of additional unloading points, the employee may press the “waiting” button and/or “additional unloading” button, or may also press the “completion” button as needed, according to the actual situation for each additional unloading point.

Upon completion of the entire delivery, the transportation vehicle leaves service, and enters the garage.

The removable storage medium is removed from the drive 18 of the vehicle-mounted apparatus 1, and inserted into the drive 38 of the server 3. The CPU 33 of the server 3 reads from the storage medium the service data regarding the entire distance, i.e., the data regarding the stored times, time-series travel distances, the stored sum of travel distances, the times and positional information at given time intervals, as well as each event, and the start time (and end time) and positional information thereof, and stores them in the storage unit 39.

In the server 3, the CPU 33 finds any “addition” events from the service data; when an “addition” event has been found, the additional distance fee determination section 42 finds an “additional unloading” event later than the “addition” event, and the travel distance determination section 41 determines, as an additional distance, the travel distance to the first additional unloading point from the start point for distance measurement at the time of a change or addition. The additional distance fee determination section 42 applies a reported freight rate to the additional distance, and determines the additional distance fee. When there are N (N>2) additional unloading points, the additional distance is calculated as the sum total of the distance between the above-mentioned start point and the first additional unloading point, the distance between the first additional unloading point and the second additional unloading point, . . . , and the distance between the (N−1)^{th} additional unloading point and the N^{th} additional unloading point. The travel distance determination section 41 may optionally determine the additional distance using current times and the information regarding the time-series travel distances or the sum data of travel distances in the service data.

The detention time fee determination section 43 finds, from the service data, any “waiting” or “completion” events during loading work; if any “waiting” or “completion” events have been found, the detention time fee determination section 43 extracts the times spent for these events, and determines the result of adding up these times as the first detention time. Further, the detention time fee determination section 43 extracts the loading time for a “loading” event, and determines, as the loading detention time, the amount of time that the sum of the first detention time and the loading time exceeds the prescribed time for the reported freight rate. The detention time fee determination section 43 then multiplies the loading detention time by a prescribed rate, to thereby determine the loading detention fee. Similarly, with respect to unloading work, the detention time fee determination section 43 of the server 3 finds, from the service data, any “waiting” or “completion” events during unloading work; if any “waiting” or “completion” events have been found, the detention time fee determination section 43 extracts the times spent for these events, and determines the result of adding these times as the second detention time. Further, the detention time fee determination section 43 extracts the unloading time for an “unloading” event, and determines, as the unloading detention time, the amount of time that the sum of the second detention time and the unloading time exceeds the prescribed time for the reported freight rate. The detention time fee determination section 43 then multiplies the unloading detention time by a prescribed rate, to thereby determine the unloading detention fee. The sum of the loading detention fee and unloading detention fee is determined as the detention fee for a single service request.

When loading or unloading has been performed a plurality of times, the loading detention fee or unloading detention fee for each time is calculated, and the sum total of these fees is determined as the detention fee for a single service request.

The overtime transportation time fee determination section 44 calculates, from the service data, a time that corresponds to late night and early morning hours from the time required for transportation excluding the rest time, and determines the distance traveled during those hours. The overtime transportation time fee determination section then determines, based on the reported freight rate, the extra fee for the distance freight rate of late night and early morning hours. Further, the overtime transportation time fee determination section 44 calculates, from the service data, a time that corresponds to regular and public holidays from the time required for transportation excluding the rest time, and determines the distance traveled during those hours. The overtime transportation time fee determination section 44 then determines, based on the reported freight rate, the extra fee for the distance freight rate of regular and public holidays. Specifically, for example, the overtime transportation time fee determination section 44 calculates the extra fee by determining the distance that the vehicle traveled during the hours that correspond to late night and early morning hours and on regular and public holidays, using, for example, the current times and any one item of information from the time-series travel distances, the sum data of travel distances, and positional information at the current points in the service data; and by applying the reported freight rate to the determined distance.

Lastly, the freight rate and fees for a single service are determined as the sum total of the reference freight rate, which is a reported distance freight rate that has previously been established, the additional distance fee, the detention fee, the extra fee for late night and early morning hours, and the extra fee for regular and public holidays.

The fees charged for a single service are determined as the sum total of the actual contract freight rate that has been established based on the reference freight rate, the additional distance fee, the detention fee, the extra fee for late night and early morning hours, and the extra fee for regular and public holidays.

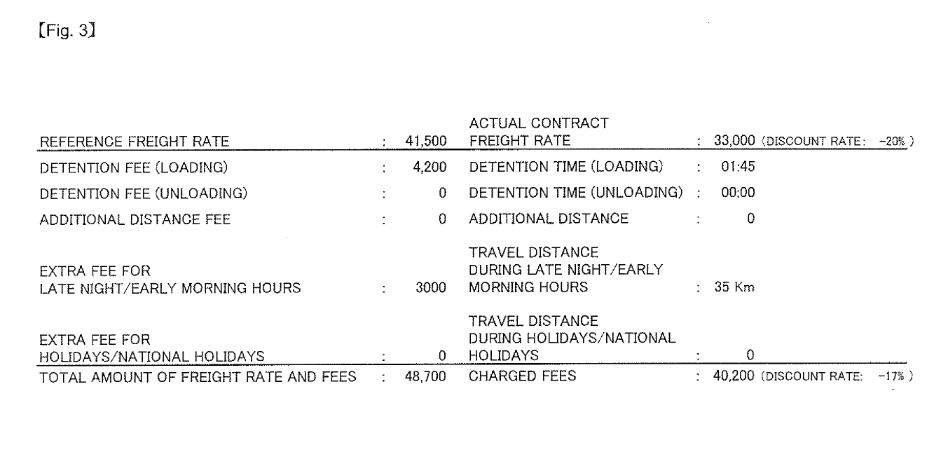

The server 3 converts the service data such as the time and distance into graphics of time-series data, displays the graphics on a display device, e.g., a display, and outputs the graphics to a printer for printing. During the conversion into graphics, the service records calculated by the above-described fee determination sections, as well as the fees therefor, may also be incorporated into the graphics. FIG. 3 shows one example of a freight rate and fee invoice showing both the additional fees and actual freight rate (the actual contract freight rate).

In this manner, the system for determining a freight rate and fees according to the invention monitors the entire distance covered by the consignment transportation using the vehicle-mounted apparatus, to store various types of information regarding service provision, and further conduct an analysis of the information. Therefore, additional travel distances, long detention times, and overtime transportation, which could not be previously proved to the client, can be presented to the client with the actual data. Further, by determining additional fees based on these actual data, the additional fees can be easily charged to the client.

While the present invention has been described using one embodiment thereof, the invention is not limited thereto. One of ordinary skill in the art will easily appreciate that the present invention can be implemented by making various modifications and additions thereto based on the disclosures herein, without departing from the scope of the appended claims.

For example, the foregoing embodiment describes, for the sake of simplicity, the case where only unloading point(s) are added; however, loading point(s) can also be added in the same manner as above. When there is an additional loading point, after the arrival at the additional loading point, an employee may press the “waiting” button at the time of waiting, and may press the “additional loading” button when loading is started. Moreover, when the employee does not depart immediately after the end of the loading work, the employee may press the “completion” button. The vehicle-mounted apparatus acquires, in response to the button operation, the start time of the “waiting”, “additional loading”, or “completion” event, as well as the current position, for storage into the storage medium. When there are a plurality of additional loading points, the employee may press the “waiting” button and/or “additional loading” button, or may also press the “completion” button as needed, according to the actual situation for each additional loading point. Furthermore, as with unloading, the analysis at the server can similarly determine, with respect to loading, the waiting time, detention time, additional distance, and the like, as well as additional charges therefor.

The server located at the main office for a transportation company may be a common personal computer. Further, instead of providing the server with the functions of the travel distance determination section 41, additional distance fee determination section 42, detention time fee determination section 43, and overtime transportation time fee determination section 44, these functions may be provided to the vehicle-mounted apparatus, in which case similar effects can also be attained. Moreover, the foregoing embodiment describes that the service information of the transportation vehicle is written into a portable storage medium; however, collected information may also be stored temporarily in RAM, and be wirelessly transmitted in real time to the server located at the main office.

Furthermore, the foregoing embodiment describes that, upon pressing each button on the vehicle-mounted apparatus, the corresponding text letters are stored; however, the buttons on the vehicle-mounted apparatus may be defined as No. 1 through No. M (the number of the function buttons), and the pressing of each button may be stored as an “ON” or “OFF” event.

What is claimed is:

1. A method for determining a freight rate and fees, the method determining fees charged for consignment transportation based on a time and distance required for transportation, using a server and a vehicle-mounted apparatus mounted in a transportation vehicle, the method comprising the steps in which:
upon receiving any of waiting, loading, completion, rest, unloading, addition, and additional loading instructions, the vehicle-mounted apparatus receives positional information of the transportation vehicle from a GPS satellite, and associates information corresponding to the received instructions with the positional information and a time at which the instructions have been received, for storage as service data;
the server determines a reference freight rate based on a reported freight rate, using a reference distance calculated based on a shortest route between designated loading and unloading points that have been found based on pre-stored map data, as well as the weight or volume of a load;
when information associated with the addition, as well as information associated with the additional unloading have been found from the service data, the server determines, as an additional distance, a distance from a position specified by stored positional information associated with the addition to a position specified by stored positional information associated with the additional unloading, to determine an additional distance fee for the additional distance;
when a loading/unloading time required for each loading or unloading event, as well as information associated with waiting and/or completion have been found from the service data, the server determines a waiting time before and/or after the event, and determines an amount of time that the sum of the waiting time and the loading/unloading time exceeds a prescribed reference time to be a detention time, to determine an additional detention fee for the detention time;
the server determines, from the service data, a distance traveled during late night and early morning hours, and a distance traveled on regular and public holidays, and multiplies each of the resulting distances by a prescribed rate to determine a sum total of the resulting values to be an extra overtime fee; and
the server determines a total amount by adding up an actual contract freight rate determined based on the reference freight rate, the additional distance fee, the detention fee, and the extra overtime fee, and determines the total amount to be the fees charged.

2. A method for determining a freight rate and fees, the method determining fees charged for consignment transportation based on a time and distance required for transportation, using a server and a vehicle-mounted apparatus mounted in a transportation vehicle, the method comprising the steps in which:
upon receiving any of waiting, loading, completion, rest, unloading, addition, and additional loading instructions, the vehicle-mounted apparatus receives positional information of the transportation vehicle from a GPS satellite, and associates information corresponding to the received instructions with the positional information and a time at which the instructions have been received, for storage as service data;
the vehicle-mounted apparatus sums up a first travel distance, which is a distance that the transportation vehicle traveled from the time of receiving loading instructions to the time of receiving unloading instructions, and a second travel distance, which is a distance that the transportation vehicle traveled from the time of receiving addition instructions to the time of receiving additional unloading instructions, and adds the sum of the first and second distances to the service data for storage;
the server determines a reference freight rate based on a reported freight rate, using the first travel distance read from the service data stored by the vehicle-mounted apparatus, and using the weight or volume of a load;
when a change or addition event for loading or unloading has been found from the service data, the server determines the second travel distance read from the service data to be an additional distance, to determine an additional distance fee for the additional distance;
when a loading/unloading time required for each loading or unloading event, as well as information associated with waiting and/or completion have been found from the service data, the server determines a waiting time before and/or after the associated event, and determines an amount of time that the sum of the waiting time and the loading/unloading time exceeds a prescribed reference time to be a detention time, to determine an additional detention fee for the detention time;
the server determines, from the service data, a distance traveled during late night and early morning hours and a distance traveled on regular and public holidays, and multiplies each of the resulting distances by a prescribed rate to determine a sum total of the resulting values to be an extra overtime fee; and
the server determines a total amount by adding up an actual contract freight rate determined based on the reference freight rate, the additional distance fee, the detention fee, and the extra overtime fee, and determines the total amount to be the fees charged.

3. A system for determining a freight rate and fees, the system estimating a reference freight rate for consignment transportation based on a reported freight rate, and determining fees charged for the consignment transportation based on a time and distance required for transportation, the system comprising a server and a vehicle-mounted apparatus mounted in a transportation vehicle, wherein:
the vehicle-mounted apparatus comprises:
a positional information acquisition unit that receives positional information of the transportation vehicle from a GPS satellite;
a time-measuring unit that acquires a time;
an operating unit that receives any of waiting, loading, completion, rest, unloading, addition, and additional unloading instructions; and
a drive that stores data in a removable storage medium; wherein:
the vehicle-mounted apparatus associates information corresponding to the received instructions with the time acquired from the time-measuring unit and the positional information acquired from the GPS satellite upon receiving the instructions, for storage into the removable storage medium as service data; and wherein:
the server comprises a drive that writes and reads to and from the removable storage medium, and performs:
transportation distance determination processing in which a shortest route from a first point to a second point is found based on pre-stored map data, and a transportation distance is determined based on the shortest route;
reference freight rate determination processing in which a reference freight rate is determined based on a reported freight rate, using a reference distance calculated by the transportation distance determination processing, taking a loading point and unloading point designated by a shipper as the first point and second point, respectively, as well as using the weight or volume of a load;
additional distance fee determination processing in which, when a change or addition event for loading or unloading has been found from the service data, an additional distance fee for an additional distance calculated by the transportation distance determination processing is determined;
detention fee determination processing in which, when a loading/unloading time required for each loading or unloading event, as well as information associated with waiting and/or completion have been found from the service data, a waiting time before and/or after the associated event is determined, and an amount of time that the sum of the waiting time and the loading/unloading time exceeds a prescribed reference time is determined to be a detention time, to determine an additional detention fee for the detention time;
extra overtime fee determination processing in which a distance traveled during late night and early morning hours and a distance traveled on regular and public holidays are determined from the service data, and each of the resulting distances is multiplied by a prescribed rate to determine a sum total of the resulting values to be an extra overtime fee; and
fee charge determination processing in which a total amount is determined by adding up an actual contract freight rate determined based on the reference freight rate, the additional distance fee, the detention fee, and the extra overtime fee, and the resulting total amount is determined to be the fees charged.

4. A system for determining a freight rate and fees, the system estimating a reference freight rate for consignment transportation based on a reported freight rate, and determining fees charged for the consignment transportation based on a time and distance required for transportation, the system comprising a server and a vehicle-mounted apparatus mounted in a transportation vehicle, wherein:
the vehicle-mounted apparatus comprises:
a positional information acquisition unit that receives positional information of the transportation vehicle from a GPS satellite;
a time-measuring unit that acquires a time;
an operating unit that receives any of waiting, loading, completion, rest, unloading, addition, and additional unloading instructions; and
a drive that stores data in a removable storage medium; wherein:
the vehicle-mounted apparatus associates information corresponding to the received instructions with the time acquired from the time-measuring unit and the positional information acquired from the GPS satellite upon receiving the instructions, for storage into the removable storage medium as service data;
the vehicle-mounted apparatus sums up a first travel distance, which is a distance that the transportation vehicle traveled from the time of receiving loading instructions to the time of receiving unloading instructions, and a second travel distance, which is a distance that the transportation vehicle traveled from the time of receiving addition instructions to the time of receiving additional unloading instructions, and adds the sum of the first and second distances to the service data for storage;
the server comprises a drive that writes and reads to and from the removable storage medium, and performs:
reference freight rate determination processing in which the first travel distance is read from the service data as a distance between a loading point and unloading point designated by a shipper, to be determined as a reference distance, and a reference freight rate is determined based on a reported freight rate, using the reference distance and the weight or volume of a load;
additional distance fee determination processing in which, when a change or addition event for loading or unloading has been found from the service data, the second travel distance is read from the service data as an additional distance, and an additional distance fee for the additional distance is determined;
additional detention fee determination processing in which, when a loading/unloading time required for each loading or unloading event, as well as information associated with waiting and/or completion have been found from the service data, a waiting time before and/or after the associated event is determined, and an amount of time that the sum of the waiting time and the loading/unloading time exceeds a prescribed reference time is determined to be a detention time, to determine an additional detention fee for the detention time;
extra overtime fee determination processing in which, based on sum data of the travel distances in the service data, a distance traveled during late night and early morning hours and a distance traveled on regular and public holidays are determined, and each of the resulting distances is multiplied by a prescribed rate to determine a sum total of the resulting values to be an extra overtime fee; and
fee charge determination processing in which a total amount is determined by adding up an actual contract freight rate determined based on the reference freight rate, the additional distance fee, the detention fee, and the extra overtime fee, and the resulting total amount is determined to be the fees charged.
